(19) United States
(12) Patent Application Publication
(10) Pub. No.: US 2018/0117684 A1
(43) Pub. Date: May 3, 2018

(54) MILLING CUTTER

(71) Applicant: MILWAUKEE ELECTRIC TOOL CORPORATION, Brookfield, WI (US)

(72) Inventors: Brian Harms, Cedarburg, WI (US); Paul Trautner, Menomonee Falls, WI (US)

(21) Appl. No.: 15/572,408

(22) PCT Filed: May 9, 2016
(86) PCT No.: PCT/US2016/031414

§ 371 Date: Nov. 7, 2017

Related U.S. Application Data
(60) Provisional application No. 62/158,576, filed on May 8, 2015.

(51) Int. Cl. B23C 5/00; B23D 65/04; B23C 5/20; B23C 5/04

(52) U.S. Cl. CPC B23C 5/006; B23D 65/04; B23C 5/207; B23C 2200/0494; B23C 2240/24; B23C 2200/206; B23C 5/04

(57) ABSTRACT

A milling cutter includes a milling drum having a body with a first end, a second end, an outer surface extending around a circumference of the body between the first and second ends, and a slot formed in the outer surface. The milling cutter also includes a cutting insert positioned at least partially within the slot and removably secured to the body. The cutting insert includes a cutting profile defined by rounded peaks and pointed valleys to cut a tooth form into a saw blade.

### CROSS-REFERENCE TO RELATED APPLICATIONS

This application claims priority to U.S. Provisional Patent Application No. 62/158,576, filed May 8, 2015, the entire contents of which are incorporated by reference herein.

### BACKGROUND

The present invention relates to milling cutters and, more particularly, to milling cutters for manufacturing saw blades.

Milling cutters are cutting tools that are rotated at a high speed to remove material from another object. Typically, milling cutters are formed of high speed steel or another hard material suitable for cutting. These milling cutters, however, are limited in life by how many times they can be re-sharpened.

### SUMMARY

In one embodiment, the invention provides a milling cutter including a milling drum having a body with a first end, a second end, an outer surface extending around a circumference of the body between the first and second ends, and a slot formed in the outer surface. The milling cutter also includes a cutting insert positioned at least partially within the slot and removably secured to the body. The cutting insert includes a cutting profile defined by rounded peaks and pointed valleys to cut a tooth form into a saw blade.

In another embodiment, the invention provides a milling cutter including a milling drum having a body with a first end, a second end, an outer surface extending around a circumference of the body between the first and second ends, and a plurality of slots formed in the outer surface. The plurality of slots are circumferentially spaced around the outer surface of the body. The milling cutter also includes a plurality of carbide cutting inserts removably secured to the body. Each carbide cutting insert is positioned at least partially within one of the plurality of slots and includes a cutting profile defined by rounded peaks and pointed valleys to cut a tooth form into a saw blade.

In yet another embodiment, the invention provides a method of manufacturing a saw blade. The method includes providing a milling cutter having a milling drum and a cutting insert. The milling drum includes a body having a first end, a second end, an outer surface extending around a circumference of the body between the first and second ends, and a slot formed in the outer surface. The cutting insert is positioned at least partially within the slot and removably secured to the body. The cutting insert includes a cutting profile defined by rounded peaks and pointed valleys. The method also includes rotating the milling cutter, engaging a saw blade blank with the milling cutter as the milling cutter is rotated, and cutting a tooth form into the saw blade blank with the cutting insert as the saw blade blank engages the milling cutter.

Other aspects of the invention will become apparent by consideration of the detailed description and accompanying drawings.

### BRIEF DESCRIPTION OF THE DRAWINGS

FIG. 1 is a perspective view of a milling cutter, the milling cutter including a milling drum and cutting inserts.

FIG. 2 is a perspective view of the milling drum shown in FIG. 1.

FIG. 3 is an end view of the milling drum of FIG. 2.

FIG. 4 is a side view of the milling drum of FIG. 2.

FIG. 5 is a perspective view of one of the cutting inserts shown in FIG. 1.

FIG. 6 is a side view of the cutting insert of FIG. 5.

FIG. 7 is a perspective view of another milling cutter, the milling cutter including a milling drum and cutting inserts.

FIG. 8 is a side view of the milling cutter of FIG. 7.

FIG. 9 is an end view of the milling cutter of FIG. 7.

FIG. 10 is a perspective view of one of the cutting inserts shown in FIG. 7.

FIG. 11 is a side view of the cutting insert of FIG. 10.

FIGS. 12A-12C illustrate a method of manufacturing a saw blade with the milling cutter shown in FIG. 7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

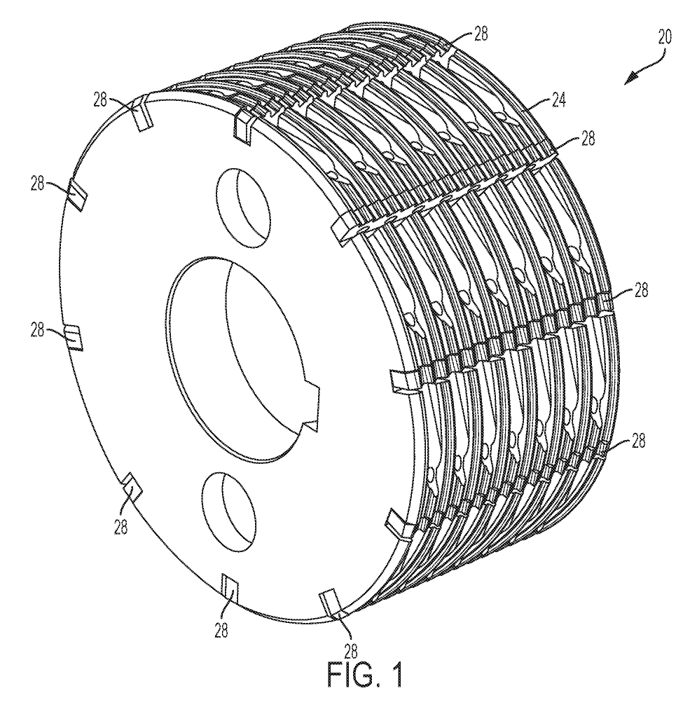

FIG. 1 illustrates a milling cutter 20. The milling cutter 20 is configured to be mounted to a milling machine and rotated at a relative high speed. As the milling cutter 20 is rotated, the milling cutter 20 cuts a tooth form, or saw tooth pattern, into a saw blade (e.g., a band saw blade, a reciprocating saw blade, or any other type of linear edge saw blade). In some embodiments, the milling cutter 20 can cut tooth forms into multiple saw blades simultaneously.

The illustrated milling cutter 20 includes a milling drum 24 and cutting inserts 28. The milling drum 24 is composed of a first material, and the cutting inserts 28 are composed of a second material that is harder than the first material. For example, the milling drum 24 may be composed of high speed steel, and the cutting inserts 28 may be composed of carbide or may be carbide coated. The cutting inserts 28 are removably secured to the milling drum 24 by threaded fasteners (e.g., screws). In other embodiments, the cutting inserts 28 may be removably coupled to the drum 24 using other suitable coupling means. In the illustrated embodiment, the milling cutter 20 includes ten cutting inserts 28 that are evenly spaced circumferentially around the milling drum 24. In other embodiments, the milling cutter 20 may include fewer more cutting inserts 28, and/or the cutting inserts 28 may be unevenly spaced around the milling drum 24.

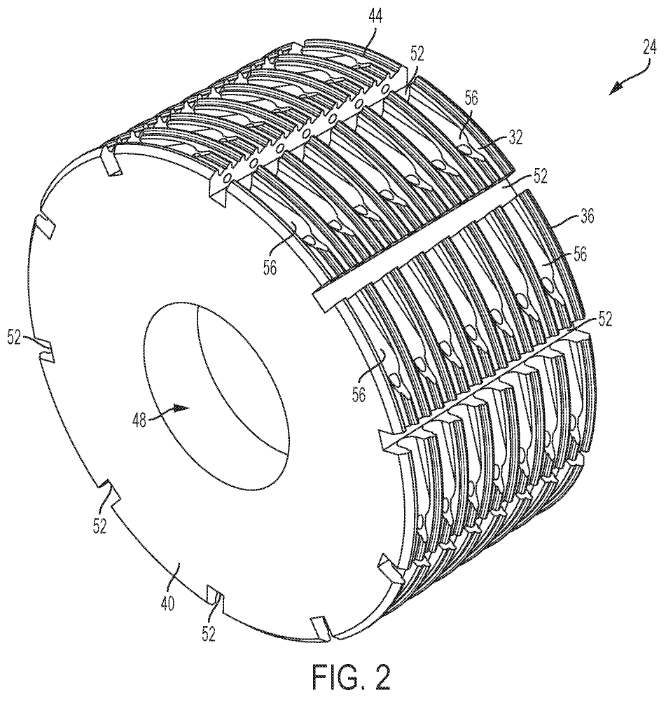

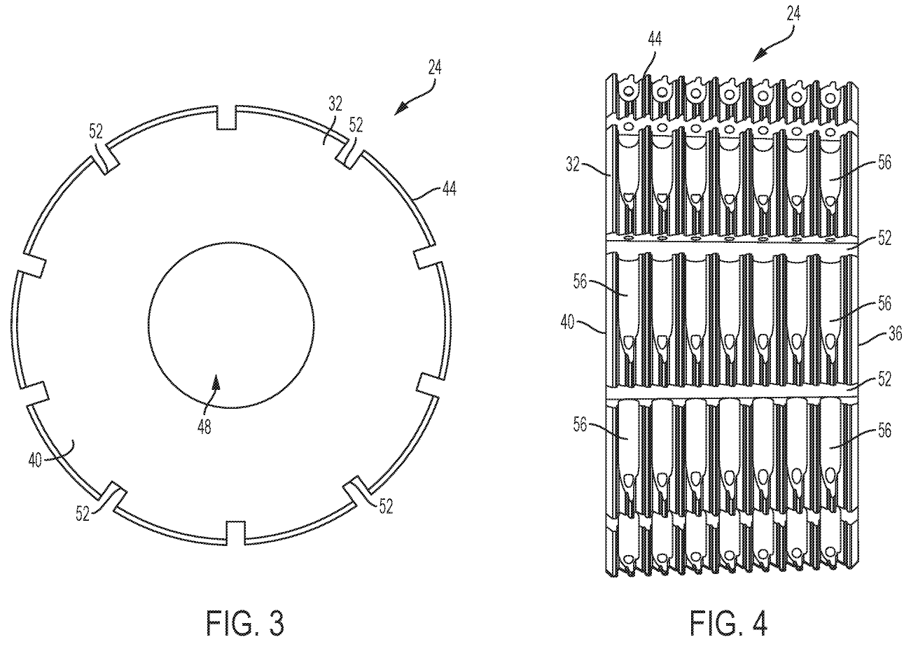

As shown in FIGS. 2-4, the milling drum 24 includes a body 32 having a first end 36, a second end 40, and an outer surface 44 extending around a circumference of the body 32 between the first and second ends 36, 40. A central bore 48 is also formed in the body 32 and extends from the first end 36 to the second end 40. The central bore 48 is configured to receive, for example, an arbor of a milling machine to rotatably mount the milling drum 24 to the machine. In the illustrated embodiment, the first end 36 of the body 32 has a first diameter and the second end 40 of the body 32 has a second diameter that is larger than the first diameter so that the body 32 is generally frustoconical-shaped. In other embodiments, the body 32 may have other shapes. For example, the first end 36 and the second end 40 may have similar diameters so that the body 32 is generally cylindrical-shaped.

The body 32 also includes slots 52 formed in the outer surface 44 of the body 32. The slots 52 extend axially along the body 32 from the first end 36 to the second end 40 and are configured to receive the cutting inserts 28. In the illustrated embodiment, the body 32 includes ten slots 52 that are evenly spaced around the circumference of the body 32, matching the number and arrangement of the cutting inserts 28. In other embodiments, the body 32 may include fewer or more slots 52 (depending on the number of cutting inserts 28), and/or the slots 52 may be unevenly spaced around the body 32. Each of the illustrated slots 52 is continuous (i.e., uninterrupted) from the first end 36 of the body 32 to the second end 40 of the body 32. In addition, each of the illustrated slots 52 is linear and extends parallel to a central longitudinal axis of the body 32.

As shown in FIGS. 2 and 4, the body 32 also includes channels 56 formed in the outer surface 44 of the body 32 and arranged generally perpendicular to the slots 52. Multiple channels 56 are associated with each slot 52. Each channel 56 is aligned with one of the fasteners that secures the cutting insert 28 within the slot 52. The illustrated channels 56 increase in depth as they approach the slots 52 to provide clearance for a tool, such as a screwdriver, to access the fasteners.

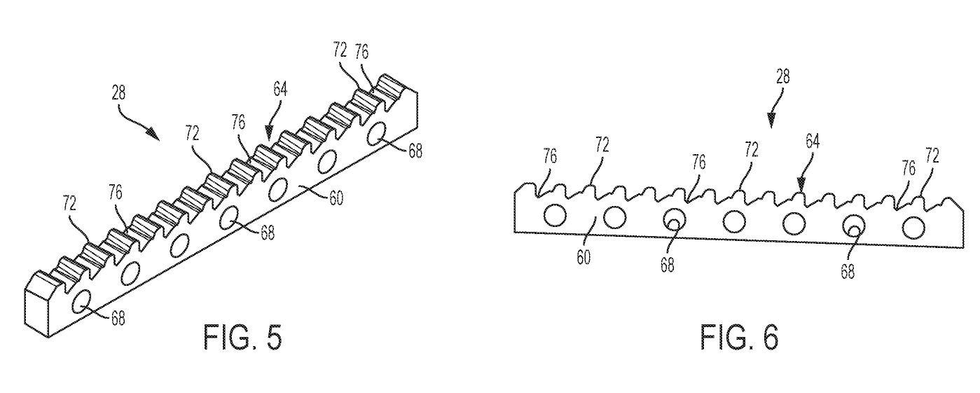

FIGS. 5 and 6 illustrate one of the cutting inserts 28. The illustrated cutting insert 28 includes a body 60, a cutting profile 64 formed along one edge of the body 60, and a series of openings 68 formed through the body 60. The body 60 is a unitary (i.e., one-piece) body having a length sufficient to extend from the first end 36 of the milling drum 24 to the second end 40 of the milling drum 24. In the illustrated embodiment, the cutting profile 64 is defined by rounded peaks 72 and pointed valleys 76. The rounded peaks 72 form curved gullets as the cutting insert 28 cuts into a saw blade, and the pointed valleys 76 form cutting teeth with relatively sharp tips as the cutting insert 28 cuts into the saw blade. In the illustrated embodiment, the cutting profile 64 is configured to cut fourteen teeth at a time into a saw blade. In other embodiments, the cutting profile 64 may be designed with fewer or less peaks 72 and valleys 76 to cut fewer or more teeth. In further embodiments, the cutting profile 64 may be modified to cut any desired tooth form or pattern into a saw blade.

The openings 68 are formed through the body 60 and spaced apart from the cutting profile 64. The openings 68 are configured to receive the fasteners to secure the cutting insert 28 to the milling drum 24. The fasteners allow the cutting insert 28 to be removed and replaced or re-sharpened if the cutting insert 28 becomes worn or damaged.

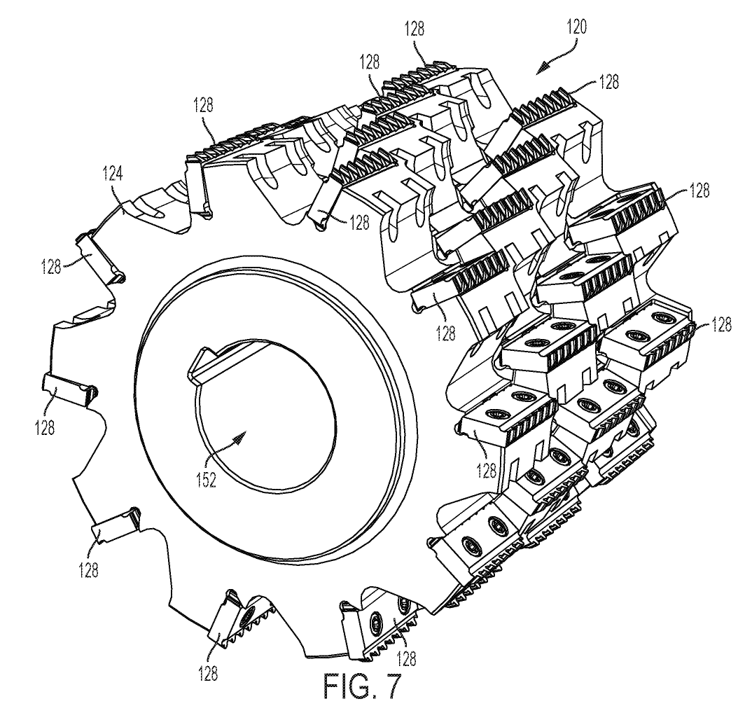

FIGS. 7-9 illustrate another milling cutter 120. The milling cutter 120 is similar to the milling cutter 20 shown in FIG. 1 and includes a milling drum 124 and cutting inserts 128. The milling drum 124 is composed of a first material, and the cutting inserts 128 are composed of a second material that is harder than the first material. For example, the milling drum 124 may be composed of high speed steel, and the cutting inserts 128 may be composed of carbide or may be carbide coated. The cutting inserts 128 are removably secured to the milling drum 124 by threaded fasteners 132 (e.g., screws). In other embodiments, the cutting inserts 128 may be removably coupled to the drum 124 using other suitable coupling means.

In the illustrated embodiment, the milling cutter 120 includes ten rows of staggered or offset cutting inserts 128. Each row includes four cutting inserts 128 that are separately secured to the milling drum 124. The cutting inserts 128 in each row are circumferentially offset from each other. In other words, the cutting inserts 128 in each row are not aligned along a longitudinal axis of the milling cutter 120. Instead, each cutting insert 128 is shifted circumferentially about the drum 124 relative to the adjacent cutting inserts 128 in the row. This arrangement allows a row of cutting inserts to progressively cut a tooth form in a saw blade, rather than having all of the cutting inserts 128 in a row contact the saw blade simultaneously. In other embodiments, the milling cutter 120 may include fewer or more rows of cutting inserts 128. Additionally or alternatively, each row may include fewer or more cutting inserts 128.

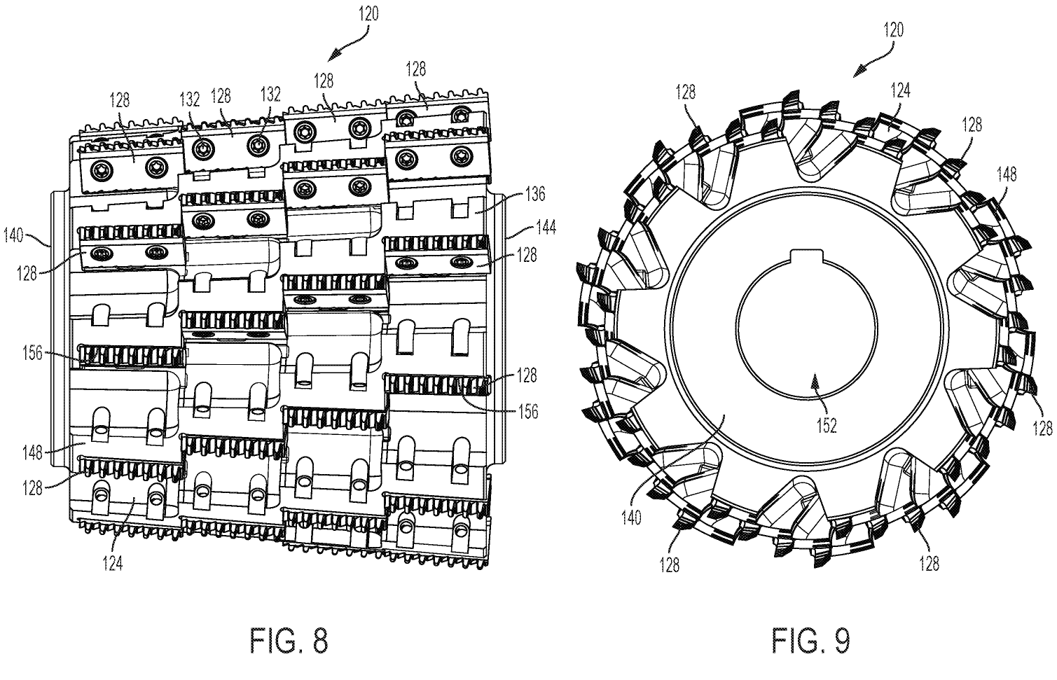

As shown in FIGS. 8 and 9, the milling drum 124 includes a body 136 having a first end 140, a second end 144, and an outer surface 148 extending around a circumference of the body 136 between the first and second ends 140, 144. A central bore 152 (FIG. 9) is also formed in the body 136 and extends from the first end 140 to the second end 144. The central bore 152 is configured to receive, for example, an arbor of a milling machine to rotatably mount the milling drum 124 to the machine. In the illustrated embodiment, the first end 140 of the body 136 has a first diameter and the second end 144 of the body 136 has a second diameter that is larger than the first diameter so that the body 136 is generally frustoconical-shaped. In other embodiments, the body 136 may have other shapes. For example, the first end 140 and the second end 144 may have similar diameters so that the body 136 is generally cylindrical-shaped.

The body 136 also includes slots 156 formed in the outer surface 148 of the body 136. The slots 156 are configured to receive the cutting inserts 128. Similar to the cutting inserts 128, the slots 156 are generally arranged in rows, with each row including four staggered or offset slots 156. With such an arrangement, the slots 156 in each row are discrete from and unaligned with each other to separately receive one of the cutting inserts 128. In other embodiments, the body 136 may include fewer or more slots 156 (depending on the number of cutting inserts 128), and/or the slots 156 may be arranged in other patterns.

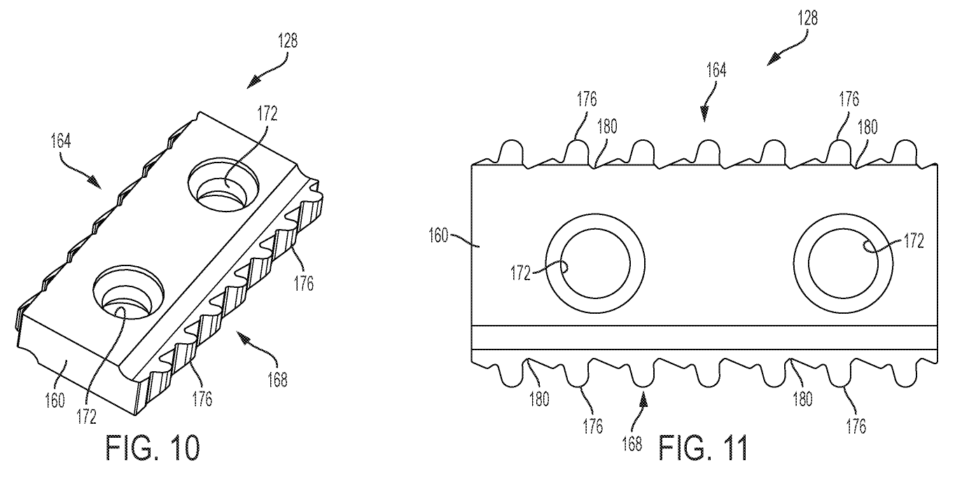

FIGS. 10 and 11 illustrate one of the cutting inserts 128. The illustrated cutting insert 128 includes a body 160, a first cutting profile 164 formed along a first edge of the body 160, a second cutting profile 168 formed along a second edge of the body 160 opposite the first edge, and two openings 172 formed through the body 160. In the illustrated embodiment, the cutting profiles 164, 168 are substantially similar and defined by rounded peaks 176 and pointed valleys 180. The rounded peaks 176 form curved gullets as the cutting insert 128 cuts into a saw blade, and the pointed valleys 180 form cutting teeth with relatively sharp tips as the cutting insert 128 cuts into the saw blade. Providing two cutting profiles 164, 168 allows the insert 128 to be reversed (e.g., rotated 180 degrees and re-secured to the milling drum 124) if one profile becomes worn or damaged. In other embodiments, the cutting profiles 164, 168 may be different to cut different tooth forms into a saw blade. Similar to the cutting inserts 28 described above with respect to FIGS. 5 and 6, the illustrated cutting inserts 128 may be modified to cut any number, shape, or pattern of cutting teeth into a saw blade.

The openings 172 are formed through the body 160 and spaced apart from both of the cutting profiles 164, 168. The openings 172 are configured to receive the fasteners 132 (FIG. 8) to secure the cutting insert 128 to the milling drum 124. The fasteners 132 allow the cutting insert 128 to be removed and rotated, replaced, or re-sharpened if the cutting insert 128 becomes worn of damaged. In the illustrated embodiment, each cutting insert 128 includes two openings 172 to receive two fasteners 132. In other embodiments, each cutting insert 128 may include fewer or more openings 172.

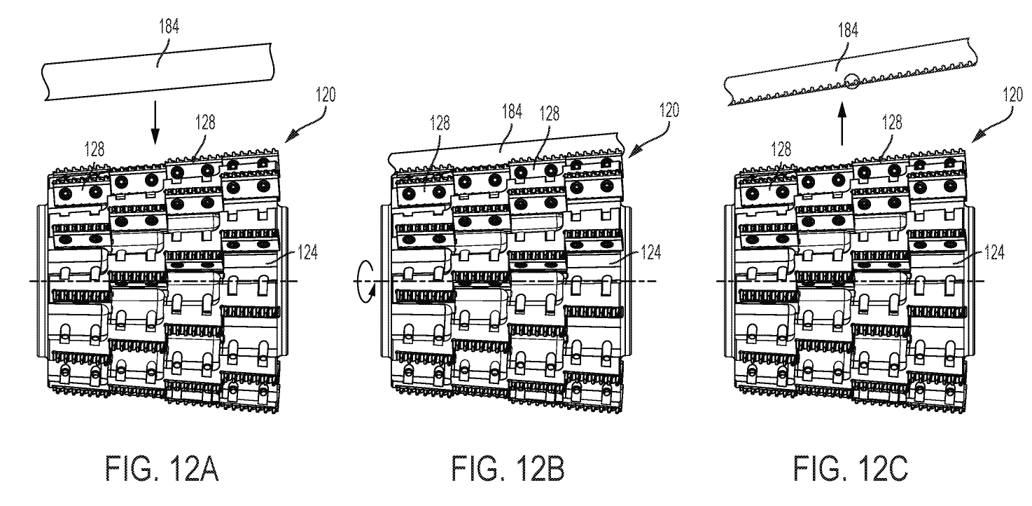

FIGS. 12A-12C illustrate a method of manufacturing a saw blade using the milling cutter 120. Operation of the milling cutter 20 shown in FIG. 1 is substantially the same as operation of the milling cutter 120 shown in FIGS. 12A-12C. In operation, the milling cutter 120 is rotated by a milling machine at a high speed to cut (e.g., grind) a series of cutting teeth into a saw blade, such as a band saw blade or reciprocating saw blade. As shown in FIG. 12A, a piece of material 184 without saw teeth, such as a length of coil stock or a saw blade blank, is moved into engagement with the milling cutter 120. As the milling cutter 120 is rotated (FIG. 12B), the cutting inserts 128 of the milling cutter 120 cut tooth forms into the piece of material 184. The tooth forms mirror the cutting profiles 164, 168 on the cutting inserts 128. After the tooth forms are sufficiently ground into the piece of material 184, the material 184 is removed from engagement with the milling cutter 120. Another piece of material (e.g., the next length of coil stock, another saw blade blank, etc.) can then be moved into alignment and engagement with the milling cutter 120.

Because the cutting inserts 28, 128 are composed of a material (e.g., carbide) having a greater hardness than a material (e.g., steel) of the milling drums 24, 124, the milling cutters 20, 120 can spin and cut faster than if the cutting profiles 64, 164, 168 were simply sharpened edges of a steel milling drum. This increased productivity allows gang cutting of multiple, side-by-side saw blades (e.g., 40+blade simultaneously), rather than cutting one saw blade at a time. In addition, since the cutting inserts 28, 128 are separate elements that are removably secured to the milling drums 24, 124, the cutting inserts 28, 128 may be removed and either rotated, re-sharpened, or replaced if the cutting inserts 28, 128 become worn or damaged.

Although the invention has been described with reference to certain preferred embodiments, variations and modifications exist with the scope and spirit of one or more independent aspects of the invention. Various features and advantages of the invention are set forth in the following claims.

1. A milling cutter comprising:
a milling drum including a body having a first end, a second end, an outer surface extending around a circumference of the body between the first and second ends, and a slot formed in the outer surface; and
a cutting insert positioned at least partially within the slot and removably secured to the body, the cutting insert including a cutting profile defined by rounded peaks and pointed valleys to cut a tooth form into a saw blade.

2. The milling cutter of claim 1, wherein the body includes a plurality of slots formed in the outer surface, and further comprising a plurality of cutting inserts, wherein each cutting insert is positioned at least partially within one of the slots and removably secured to the body, and further wherein each cutting insert includes a cutting profile defined by rounded peaks and pointed valleys.

3. The milling cutter of claim 2, wherein the plurality of slots and the plurality of cutting inserts are circumferentially spaced around the outer surface of the body.

4. The milling cutter of claim 3, wherein each slot is continuous from the first end of the body to the second end of the body.

5. The milling cutter of claim 4, wherein each slot is linear.

6. The milling cutter of claim 3, wherein the plurality of slots are evenly spaced around the outer surface of the body.

7. The milling cutter of claim 1, wherein the cutting insert includes a unitary body that extends from the first end of the body to the second end of the body.

8. The milling cutter of claim 1, wherein the first end of the body has a first diameter and the second end of the body has a second diameter that is larger than the first diameter so that the body is generally frustoconical-shaped.

9. The milling cutter of claim 1, wherein the cutting insert is removably secured to the body by a threaded fastener.

10. The milling cutter of claim 1, wherein the milling drum is composed of a first material, and the cutting insert is composed of a second material that is harder than the first material.

11. The milling cutter of claim 10, wherein the milling drum is composed of high speed steel, and the cutting insert is composed of carbide or is carbide coated.

12. A milling cutter comprising:
a milling drum including a body having a first end, a second end, an outer surface extending around a circumference of the body between the first and second ends, and a plurality of slots formed in the outer surface, the plurality of slots being circumferentially spaced around the outer surface of the body; and
a plurality of carbide cutting inserts removably secured to the body, each carbide cutting insert positioned at least partially within one of the plurality of slots and including a cutting profile defined by rounded peaks and pointed valleys to cut a tooth form into a saw blade.

13. The milling cutter of claim 12, wherein the plurality of slots and the plurality of carbide cutting inserts are evenly circumferentially spaced around the outer surface of the body.

14. The milling cutter of claim 12, wherein each slot is continuous from the first end of the body to the second end of the body, and wherein each carbide cutting insert includes a unitary body that extends from the first end of the body of the milling drum to the second end of the body of the milling drum.

15. The milling cutter of claim 14, wherein the plurality of slots are evenly spaced around the outer surface of the body.

16. The milling cutter of claim 12, wherein the first end of the body has a first diameter and the second end of the body has a second diameter that is larger than the first diameter so that the body is generally frustoconical-shaped.

17. The milling cutter of claim 12, wherein each carbide cutting insert is removably secured to the body by a threaded fastener.

18. A method of manufacturing a saw blade, the method comprising:
providing a milling cutter including a milling drum and a cutting insert, the milling drum including a body having a first end, a second end, an outer surface extending around a circumference of the body between the first and second ends, and a slot formed in the outer surface, the cutting insert being positioned at least partially within the slot and removably secured to the body, the cutting insert including a cutting profile defined by rounded peaks and pointed valleys;
rotating the milling cutter;
engaging a saw blade blank with the milling cutter as the milling cutter is rotated; and
cutting a tooth form into the saw blade blank with the cutting insert as the saw blade blank engages the milling cutter.

19. The method of claim 18, wherein the cutting insert is removably secured to the body by a threaded fastener, and further comprising removing the cutting insert from the body by disconnecting the threaded fastener from the body.

20. The method of claim 18, further comprising:
engaging multiple saw blade blanks with the milling cutter as the milling cutter is rotated; and
cutting a tooth form into each saw blade blank with the cutting insert as the multiple saw blade blanks engage the milling cutter.
